(19) United States
(12) Patent Application Publication
(10) Pub. No.: US 2009/0031400 A1
(43) Pub. Date: Jan. 29, 2009

(54) SYSTEM, METHOD AND COMPUTER READABLE MEDIUM FOR TRANSFERRING CONTENT FROM ONE DVR-EQUIPPED DEVICE TO ANOTHER

(75) Inventor: Allen James Anderson, Katy, TX (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/960,408

(22) Filed: Dec. 19, 2007

Related U.S. Application Data
(60) Provisional application No. 60/952,224, filed on Jul. 26, 2007.

(51) Int. Cl. G06F 21/20; G06F 17/30

(52) U.S. Cl. 726/4; 707/10; 707/E17.032

(57) ABSTRACT

A headend for providing content over a broadband communication network, includes an input for receiving content to be broadcast to subscriber devices over the network. The headed also includes a multiplexer for multiplexing video streams received from the input and a modulator for modulating the multiplexed video streams onto the broadband communications network. A content authorization server is provided in the headend for authorizing transfer of selected content residing on a first subscriber device to a second subscriber device by sequentially transferring blocks of the selected content. The individual blocks are transferred to the second subscriber device and removed from the first subscriber device before subsequent blocks of the selected content are transferred.

### RELATED APPLICATION DATA

This application claims the benefit of U.S. Provisional Patent Application Ser. No. 60/952,224, filed Jul. 26, 2007, entitled “System, Method and Computer Readable Medium for Transferring Content from One DVR to Another”, which is incorporated by reference herein in its entirety.

### FIELD OF THE INVENTION

This invention relates to moving content from one recording medium to another. In particular, the invention transfers content from one storage medium such as a DVR to another so that copy protection of the content is preserved.

### BACKGROUND

Many people have devices that record broadcast video content. Such devices are typically called digital video recorders (DVRs) or personal video recorders (PVRs). DVRs are sometimes incorporated in other devices that offer additional functionality. For example, as a subscriber to an MSO (Multiple Service Operator) service, the user may rent or buy a set top box that includes a DVR. In addition to the DRV, the set top box also includes other components such as tuners, demodulators, decoders, decryptors, modulators, various input and output ports and infrared sensors for remote controls.

Content owners are concerned about protecting their content when in digital form. Digital copies of content preserve their quality through subsequent copying, unlike analog copies. However, the potential unauthorized copying of stored content poses a significant problem for content providers and MSO's Since the programs stored on a DVR may be considered to be valuable, it is desirable to protect the content on the disk from unauthorized access, either by the subscriber or by others who might come into possession of the set top box. To overcome this problem the programs are often stored on the storage medium in an encrypted form using a private encryption key that is unique to each and every set top box. The private encryption key is often stored in a secure hardware portion of the set top box so that it is available to encrypt and decrypt the stored programs. Unfortunately, one problem with this approach is that if the set top box should fail so that the private encryption key is not able to be accessed, the programs stored in the storage medium cannot be decrypted even though the storage medium itself may be intact and the data otherwise accessible. As a result, the programs that the user has stored on the storage medium drive cannot be transferred to a replacement set top box. Thus, a user who may have recorded hours of content may lose it all when receiving a replacement set top box.

### BRIEF DESCRIPTION OF THE DRAWINGS

FIG. 1 is a block diagram of a communications system that includes a set top box having a digital storage medium to provide DVR type functionality.

FIG. 2 shows one example of an arrangement for transferring content from one electronic content storage medium (e.g., a set top box) to another electronic content storage medium.

FIG. 3 shows one example of network headend in which the content authorization server may reside.

FIG. 4 shows one example of a process that may be employed for transferring a selected content file from a first electronic content storage medium to a second electronic content storage medium.

FIG. 5 shows another example of an arrangement for transferring content from one electronic content storage medium (e.g., a set top box) to another electronic content storage medium.

### DETAILED DESCRIPTION

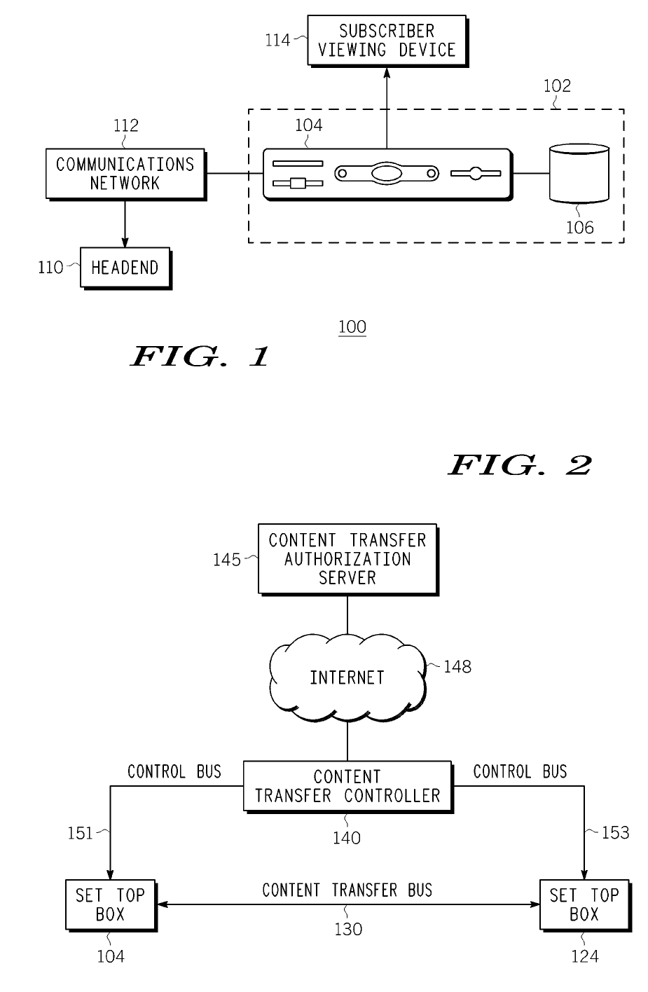

FIG. 1 is a block diagram of a communications system 100 that includes a set top box 104 having a digital storage medium 106 to provide DVR type functionality. The digital storage medium 106 (e.g., a hard disk drive—“HDD”) may be either internal or external to the set top box 104 and is used for storing program content.

The set top box 104 is connected via a broadband communications network 112 to the headend 110 of a service provider or MSO that provides broadcast and/or subscription program content. Typically, the communications network 112 is a cable, hybrid fiber/coax or satellite transmission network. Network 112 could, alternatively, employ any other suitable communication links, such as a wired and/or wireless broadband Internet, local area network (LAN), or wide area network (WAN) connection. Program content from the headend 110 is decoded and, if the content is encrypted, then the content is decrypted by the set top box for viewing, listening or otherwise rendering on a subscriber's rendering device 114 (e.g., television, media center, stereo system, personal computer, handheld device, etc.).

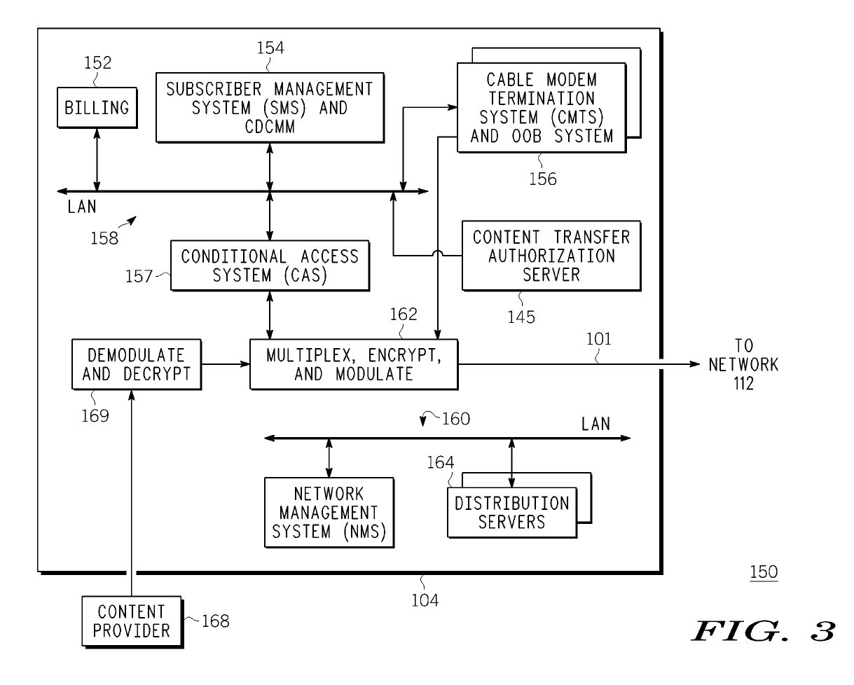

As previously mentioned, for a variety of reasons a user may wish to transfer content from the digital storage medium 106 of set top box 104 to the digital storage medium 106 of another set top box. Content owners, however, will only allow such a transfer if they can be ensured that only legitimate, authorized content transfer occurs and unauthorized copying of stored content is prevented. A simple and convenient method of performing such a transfer while respecting the content owners' rights will be illustrated in connection with FIG. 2.

FIG. 2 shows one example of an arrangement for transferring content from set top box 104 to set top box 124. A content transfer controller 140 is provided for controlling the overall operation of the transfer process and to ensure that the transfer is only performed in accordance with a procedure approved by the content owner (or their agent or other designee) which ensures that the content will be protected from unauthorized copying. The content transfer controller 140 has networking capabilities so that it can communicate with a remotely located content transfer authorization server 145 over a packet-switched network 148 such as the Internet, for example. The content transfer controller 140 may be a general purpose device such as a PC, PDA or the like. Alternatively, the content transfer controller 140 may be a special purpose device that is exclusively dedicated to controlling the content transfer process. The content transfer controller 140 communicates with the set top terminals 104 and 124 over control busses 151 and 153, respectively. A content transfer bus 130 provides communication between the set top boxes 104 and 124. In some cases busses 130, 151 and 153 may comply with a communication standard such as the Universal Serial Bus (USB) standard or the IEEE 1394 digital interface standard.

A content file from the first set top box 104 is transferred to the second set top terminal 124 as follows. The content transfer controller 140 is first authenticated by the content authorization transfer 145 to allow such content transfer. Once authenticated, the content transfer controller 140 requests a first block of the content file from the first set top terminal 104. This block which may vary in size depending on a number of implementation-specific details, is only a portion of an entire content file (e.g., a program) that is to be transferred. The first block of data is then written onto the storage medium of the second set top box 124. Once confirmation that the first block has been written onto the second set top box has been received by the content transfer controller 140, the controller 140 instructs the first set top box 104 to erase the first block from its storage medium. In some cases confirmation will only be sent to the controller 140 after the second set top box 124 performs a check (e.g., a cyclic redundancy check) to ensure that the entire block of data has been properly written. Once the controller 140 has confirmation that the first block of data has been erased from the first set top terminal 104, a second block of data from the first set top terminal 104 is read and the process continues. Accordingly, at no time is an entire content file in existence on both set top terminals. For a brief time, a block of the content file is kept in both set top terminals; however another block cannot be transferred until the previous block is deleted. Thus, even if a hacker were to subvert this system, he would only be able to copy a portion of the content file.

As described above, blocks of content are sequentially transferred directly from the storage medium of one set top terminal to the storage medium of another set top terminal. However, in some cases an additional degree of security may be provided by first transferring the blocks of content from the storage medium of the first set top box to a volatile memory in the second set top box, which serves to buffer the blocks. Once the content transfer controller 140 receives confirmation that a block of content has been buffered by the second set top box 124, the controller 140 instructs the first set top box 104 to erase the block from its storage medium. Only after receiving confirmation that the block of content has been erased will the controller 140 instruct the second set top box 124 to transfer the block from its volatile memory to its persistent or non-volatile memory (e.g., magnetic memory, semiconductor memory, optical memory). In this way a block of content will never be present on two non-volatile storage media at the same time.

After all of entire content file has been transferred from the first set top box 104 to the second set top box 124, the content transfer controller may generate a record or report that is sent to the content transfer authorization server. This record or report keeps track of which set top boxes have been involved in a file transfer. Thus, if a first set top box is asked to transfer a content file to a second set top box on one day and a third set top box on another day, the content transfer authorization server 145 would recognize this from its reports and deny the transfer of the content file from the first set top box to the third set top box.

As noted above, the transfer process begins with an authentication step. In the authentication step the content transfer controller 140 and the set top terminals 104 and 124 are all authenticated by the content authorization server. Proper authentication includes identifying the various devices to ensure that they are who they purport to be. In addition, authentication may include a confirmation that the selected content is content that is eligible for transfer between the two devices that have been properly identified. That is, some content files may be ineligible for transfer between any two devices under any circumstances. In other cases a content file may be eligible for transfer under certain circumstances but not between the devices that have been identified. If any one device is not authenticated, the content cannot be transferred. The content transfer controller can be authenticated by any of a variety of different techniques. For example, the content transfer controller may be identified by a unique serial number or the like that is placed in a secure, protected area of the controller so that it is inaccessible both to users and to hackers. One example of secure, protected storage is the on-chip PROM or FLASH memory of a microcontroller chip that can be programmed to make readout of data stored therein impossible except by internal access by the microcontroller itself. This type of secure storage capability exists in many modern microprocessors and microcontrollers as protection against unauthorized duplication of sensitive data or program information. Another example of secure, protected storage is PROM or FLASH memory external to a microprocessor chip but internal to the content transfer controller. Although not quite as secure as the internal protected memory of a microprocessor chip, such PROM and FLASH memory is sufficiently difficult for a user or hacker to access that it provides a considerable barrier to accessing the contents thereof.

The content authorization server 145 can authenticate the set top boxes 104 and 124 in a manner similar to the authentication of the content transfer controller 140. This can be accomplished even if, as in FIG. 2, the authorization server is not in direct communication with the set top terminals 104. For instance, once the content transfer controller has been authenticated, it in turn can be used to authenticate the set top boxes 104 and 124 via the control busses 151 and 153, respectively. Of course, in some cases it may be desirable to provide a direct communication link between the content transfer authorization server and the set top boxes 104 and 124 in order to perform authentication.

The content transfer process described above can be made resistant to tampering if at any point during the process a user or hacker attempts to tap into the system by connecting a third recording device to either of the set top boxes in order. Since USB, IEEE 1394 and other similar communication standards allow a device to automatically recognize when an external device is connected through a bus using one of these standards, the content transfer controller 140 can be configured to immediately shut down the content transfer process whenever the presence of a third recording or other device is detected.

In some cases content authorization server 145 may be located in the network headend 110, an example of which is shown in FIG. 3. As shown, the headend 150 comprises typical headend components and services including billing module 152, subscriber management system (SMS) and client device configuration management module (CDCMM) 154, cable-modem termination system (CMTS) and (out-of-band) OOB system 156, as well as LAN(s) 158 and 160 for placing the various components in data communication with one another. Headend 110 also includes content transfer authorization server 145. It will be appreciated that while a bar or bus LAN topology is illustrated, any number of other arrangements (e.g., ring, star, etc.) may be used. The headend receives content from a content provider 168. The content transfer authorization server 145 can implement policies established by the content provider 168 for the transfer of content from one set top box to another set top box. The content is received by a demodulator and decryptor 169 in the headend. Distribution servers 164, which are coupled to the LAN 160, store applications, upgrades, and the like that are to be downloaded to the set top boxes.

The headend 150 of FIG. 3 further includes a multiplexer/encrypter/modulator (MEM) 162 coupled to the broadband network 112 (see FIG. 1) and the demodulator and decryptor 169. The MEM 162 is adapted to “condition” content for transmission over the broadband network 112. In a typical broadband network, information is carried across multiple channels. Thus, the headend must be adapted to acquire the information for the carried channels from various sources. Typically, the content residing on the different channels being delivered from the headend 150 to the set top boxes (“downstream”) is multiplexed together in the headend and sent to neighborhood hubs (not shown) as a multiplexed video stream. That is, the multiplexed video streams are modulated by the MEM 162 onto broadband communication network 112. It will also be appreciated that the headend configuration depicted in FIG. 2 is a high-level, conceptual architecture and that each network may have multiple headends deployed using different architectures.

It should be noted that while the above examples describe the transfer of content from one set top box to another set top box, the same techniques may be used to transfer content between any of a variety of different devices that include content storage media. Such devices include, without limitation, free-standing DVR's, PCs, PDAs, cell phones, video game consoles, digital audio players and portable memory devices.

It should also be noted that other variations are possible on the process described above. For example, the content transfer authorization server 145 could periodically issue or request tickets or re-authentication of the various devices throughout the content transfer process. Thus, even if one certificate is comprised, only a portion of the content file will be transferred before the process is terminated. For instance, such reauthorization could be required after a certain number (e.g., 1, 2, 3, etc.) of blocks have been successfully transferred. In addition, while the above example is described using a content transfer controller as that serves as an intermediary for controlling the transfer process, the necessary control software, firmware and the like embodied in the controller could be kept in the set top boxes themselves, thereby eliminating the need for a separate controller.

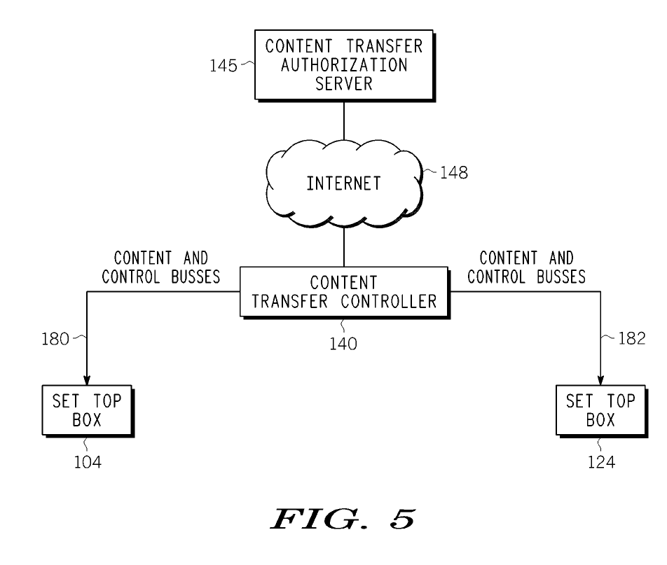

In another variant, shown in FIG. 5, the content transfer controller 140 may be configured so that the content is transferred first one set top terminal to the controller 140 (via content and control busses 180) and then from the controller 140 to the second set top terminal (via content and control busses 182). In yet another variant, the content may be transferred from one set top terminal to another intermediary device before being transferred to the second set top terminal, while the entire process is under the control of the content transfer controller 140.

It should also be understood that while the above examples describe using a hard drive as the electronic storage medium, other types of electronic memory may be used to store content such as semiconductor memory or optical memory.

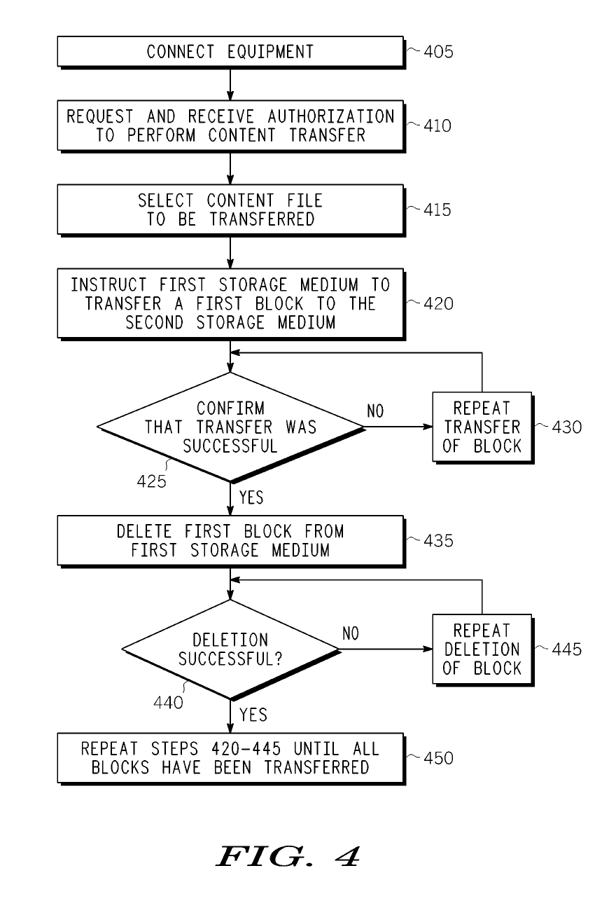

FIG. 4 shows one example of a process that may be employed for transferring a selected content file from a first electronic content storage medium to a second electronic content storage medium. After properly connecting the first and second storage media to one another and to the content transfer controller in step 405, the content transfer controller requests and receives authorization to perform the transfer from the content transfer authorization server in step 410. In step 415 the user selects the content file that is to be transferred. Depending on the particulars of the system configuration, the selection may be performed through a user interface associated with either the first or second storage media or the content transfer controller. In step 420 the content transfer controller instructs the first storage medium to transfer a first block of the selected content file to the second content storage medium. The second storage medium determines if the transfer was successful in step 425. If the transfer was not successful, then in step 430 the content transfer controller repeats the transfer of the first block until the transfer is successful. Once the transfer of the first block has been successfully completed, the content transfer controller in step 435 instructs the first storage medium to delete or otherwise remove or make inaccessible the first block of the content file. The first storage medium determines if the deletion was successful in step 440. If the deletion was not successful, then in step 445 the deletion step is repeated until it is successful. Finally, in step 450, the successive blocks of the content file are transferred in accordance with steps 420-445 until the last block of the content file has been successfully transferred.

The processes described above, including but not limited to those presented in connection with FIG. 4, may be implemented in general, multi-purpose or single purpose processors. Such a processor will execute instructions, either at the assembly, compiled or machine-level, to perform that process. Those instructions can be written by one of ordinary skill in the art following the description of presented above and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

1. A method of transferring a selected content file from a first electronic content storage medium to a second electronic content storage medium, comprising:
(i) receiving authorization to perform a transfer of the selected content file from the first to the second content storage media;
(ii) causing a first block of the selected content file to be transferred from the first content storage medium to the second content storage medium;
(iii) after performing step (ii), causing the first block of the selected content file to be removed from the first content storage medium;
(iv) after performing step (iii), causing a second block of the selected content file to be transferred from the first content storage medium to the second content storage medium;
(v) after performing step (iv), causing the second block of the selected content file to be removed from the first content storage medium; and
(vi) sequentially repeating step (iv) and (v) for any remaining blocks of the selected content file.

2. The method of claim 1 wherein the blocks of the content file are caused to be transferred and removed from the first content storage medium by a content transfer controller and further comprising establishing communication between the content transfer controller and a content authorization server so that the authorization may be received from the content authorization server.

3. The method of claim 2 wherein the authorization includes authenticating the first and second content storage media and the content transfer controller.

4. The method of claim 1 wherein the authorization further includes receiving confirmation that the selected content file is eligible for transfer between the authenticated first and second storage media.

5. The method of claim 1 wherein the first and second blocks are transferred directly from the first to second content storage media over a communications bus.

6. The method of claim 1 further comprising generating a report identifying the selected content file and the first and second storage media and transmitting the report to the content authorization server.

7. The method of claim 1 further comprising terminating transfer of any remaining blocks if any additional device is detected as being in communication with either the first or the second storage media.

8. The method of claim 1 wherein the communications bus conforms to a USB or IEEE 1394 standard.

9. The method of claim 1 wherein at least one of the first and second content storage media is located in a set top box.

10. The method of claim 9 wherein the authorization is received from a headend over a broadband communications network.

11. The method of claim 1 wherein steps (ii and iii) further comprise transferring the first block from the first content storage medium to a volatile memory associated with the second content storage medium and transferring the first block from the volatile memory to non-volatile memory in the second content storage medium after causing the first block to be removed from the first content storage medium.

12. The method of claim 1 wherein, after transferring a given number of blocks, receiving reauthorization to perform the transfer before continuing to transfer the remaining blocks.

13. At least one computer-readable medium encoded with instructions which, when executed by a processor, performs the method set forth in claim 1.

14. The method of claim 1 wherein the blocks of the content file are caused to be transferred and removed from the first content storage medium by a content transfer controller and further comprising establishing communication between the content transfer controller and a content authorization server over a packet-switched network so that the authorization may be received from the content authorization server.

15. A headend for providing content over a broadband communication network, comprising:
an input for receiving content to be broadcast to subscriber devices over the network;
a multiplexer for multiplexing video streams received from the input;
a modulator for modulating the multiplexed video streams onto the broadband communications network; and
a content authorization server for authorizing transfer of selected content residing on a first subscriber device to a second subscriber device by sequentially transferring blocks of the selected content, wherein individual blocks are transferred to the second subscriber device and removed from the first subscriber device before subsequent blocks of the selected content are transferred.

16. The headend of claim 15 wherein the content authorization server is configured to authenticate a content transfer controller that causes the sequential transfer of blocks from the first subscriber device to the second subscriber device.

17. The headend of claim 15 wherein the content authorization server is configured to confirm that the selected content file is eligible for transfer between the authenticated first and second storage media.

18. The headend of claim 16 wherein the content authorization server is configured to receive a report from the content transfer controller which identifies the selected content file and the first and second storage media.

19. The headend of claim 15 wherein at least one of the subscriber devices is a set top box.

20. The headend of claim 15 wherein the content authorization server is further configured to re-authorize transfer of remaining blocks after a given number of blocks have been transferred to the second subscriber device
